(19) United States
(12) Patent Application Publication
(10) Pub. No.: US 2004/0146340 A1
(43) Pub. Date: Jul. 29, 2004

(54) Hydroformed tubular structure

(76) Inventor: Mark C. Smith, Troy, MI (US)

Correspondence Address: CARLSON, GASKEY & OLDS, P.C., 400 WEST MAPLE ROAD, SUITE 350, BIRMINGHAM, MI, 48009, US

(21) Appl. No.: 10/349,586

(22) Filed: Jan. 23, 2003

(51) Int. Cl. F16B 12/04

(52) U.S. Cl. 403/265

(57) ABSTRACT

A method and apparatus is provided for strengthening tubular members and attaching structures to the tubular member using a hydroforming process. An outer tube is used to provide stiffness and attachment features for attaching the structure to the tubular member without the use of welds. The outer tube is placed over an inner tube and the tubular structure is placed into a die. Oil is injected into the inner tube at high pressures to positively deform the inner tube into engagement with locating feature of the outer tube. In one embodiment, the outer tube has a non-circular inner surface and the inner tube has an outer surface with a shape different than the non-circular inner surface. Plastically deforming the inner tube during the hydroforming process laterally locks the tubes relative to one another while preventing relative rotation between the tubes. In a second embodiment, the outer tube has an outer edge with a portion that is not perpendicular to the longitudinal axis of the inner tube. The outer edge prevents relative rotation between the tubes. The outer tube of the second embodiment may be cut from a tube at the outer edge to form a plurality of outer tubes from a single tube assembly. Preferably, the inner tube has a higher Young's modulus so that once the high pressure is removed the hydroforming process the inner tube will not contract as much as the outer tube.

### BACKGROUND OF THE INVENTION

This invention relates to a tubular structure, and more particularly, the invention relates to a hydroformed tubular structure suitable for use in manufacturing vehicle frames and suspensions.

Tubular structures are commonly used in the manufacture of vehicle frames and suspensions. To obtain the desired stiffness of the tubular member, either a thicker walled tube is used or reinforcing members are welded in the area needing stiffening. Occasionally, mass dampers are used for suspensions to dampen the suspension. The structure providing the mass is typically welded to the tubular member.

Welding is a costly process and difficult to control resulting in poor welds. Frequently, the weld becomes an area of weakness and fails rendering the structure useless. It is desirable to utilize tubular members having as thin of a wall thickness as possible while providing localized stiffness in highly stressed areas without the use of welds. Furthermore, it is desirable to attach masses or other structures to the tubular member without the use of welds.

### SUMMARY OF THE INVENTION AND ADVANTAGES

The present invention provides a method and apparatus for strengthening tubular members and attaching structures to the tubular member using a hydroforming process. An outer tube is used to provide stiffness and attachment features for attaching the structure to the tubular member without the use of welds. The outer tube is placed over an inner tube and the tubular structure is placed into a die. Oil is injected into the inner tube at high pressures to positively deform the inner tube into engagement with locating feature of the outer tube. In one embodiment, the outer tube has a non-circular inner surface and the inner tube has an outer surface with a shape different than the non-circular inner surface. Plastically deforming the inner tube during the hydroforming process laterally locks the tubes relative to one another while preventing relative rotation between the tubes. In a second embodiment, the outer tube has an outer edge with a portion that is not perpendicular to the longitudinal axis of the inner tube. The outer edge prevents relative rotation between the tubes. The outer tube of the second embodiment may be cut from a tube at the outer edge to form a plurality of outer tubes from a single tube assembly. Preferably, the inner tube has a higher Young's modulus so that once the high pressure is removed during the hydroforming process the inner tube will not contract as much as the outer tube.

Accordingly, the above invention provides a method and apparatus of reinforcing a tubular member without the use of welds.

### BRIEF DESCRIPTION OF THE DRAWINGS

Other advantages of the present invention can be understood by reference to the following detailed description when considered in connection with the accompanying drawings wherein:

FIG. 1A is a first tubular structure produced by hydroforming process;

FIG. 1B is an end view of the tubular structure show in FIG. 1A;

FIG. 2A is a second tubular structure produced by a hydroforming process;

FIG. 2B is an end view of the tubular structure shown in FIG. 2A;

FIG. 2C is a cross-sectional view taken along lines 2C-2C of FIG. 2A; and

FIG. 3 is an elevational view of an outer tube assembly from which numerous outer tubes may be cut similar to the outer tube shown in FIG. 2A.

### DETAILED DESCRIPTION OF THE PREFERRED EMBODIMENT

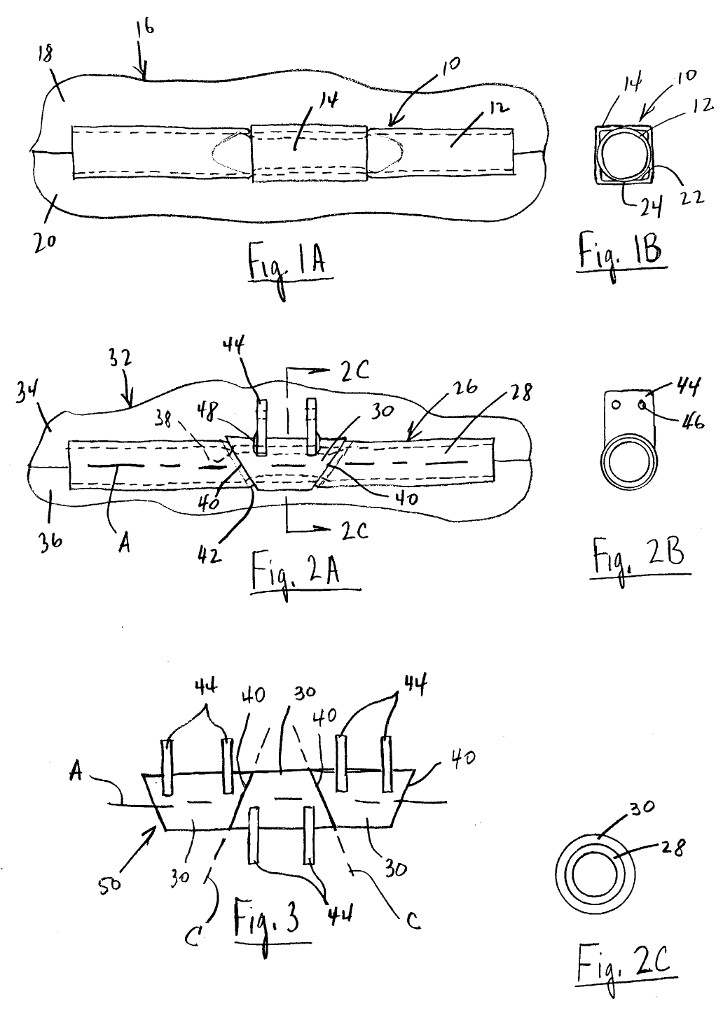

An outer tube 14 is arranged concentrically to the inner tube 12, as shown in FIGS. 1A and 1B. The tubular structure 10 is suitable for vehicle structured such as frames or suspensions. The tubular structure 10 is formed in a die 16 between first 18 and second 20 die portions. A hydroforming process, as known in the art, is used to plastically deform the tubes 12 and 14 into a desired shape defined by the inner surface of the die 16. Highly pressurized oil fills the inner cavity of the inner tube 12 to force the tubes 12 and 14 into engagement with the die surface.

The first embodiment of the present invention used tubes that have overlapping interlocking portions of a non-circular shape to lock the tubes together against rotation. The outer tube 14 preferably includes a non-circular final deformed inner surface 22, such as a rectangular or square surface. The inner tube 12 has a final deformed outer surface 24 outboard of the outer tube 14 that is of a different shape than the non-circular inner surface 22 of the outer tube 14. Preferably, the outer surface 24 is circular for improved strength in the areas not reinforced by the outer tube 14. The outer surface 24 of the inner tube 12 is deformed into engagement with the square inner surface 22 of the outer tube 14 thereby locking the tubes 12 and 14 together against rotation relative to one another. The outer surface 24 of the inner tube 12 extends radially slightly beyond the inner surface 22 of the outer tube 14 thereby laterally locating the tubes 12 and 14 relative to one another.

In aspect of the present invention the inner 12 and outer 14 tubes may be of a different stiffness to better lock the tubes to one another. For example, the inner tube 12 may have a higher Young's modulus than the outer tube 14 so that once the pressure is removed during the hydroforming process the inner tube will relax less than the outer tube thereby shrinking the outer tube further onto the inner tube. This may be accomplished, for example by using titanium for the outer tube and steel for the inner tube.

It should be understood that the inner 12 and outer 14 tubes may have any initial cross-sectional shape prior to hydroforming. It should further be understood that the tubes 12 and 14 may be plastically deformed into any cross-sectional shape during the hydroforming process.

Another tubular structure 26 is shown in FIGS. 2A-2C. The tubular structure 26 includes an inner tube 28 and an outer tube 30 arranged concentrically over the inner tube 28. The structure 26 is placed in a die 32 having first 34 and second 36 die portions defining a desired shape for the hydroformed structure 26.

The structure 26 has a longitudinal axis A where the tubes 28, 30 overlap one another. However, it is to be understood that the structure 26 may have numerous bends that may not be arranged concentrically along the longitudinal axis A over the entire length of the structure 26. The outer tube 30 includes an inner surface 38 and an outer edge 40 transverse to the axis A. The outer edge 40 is non-perpendicular to the axis A. Said another way, the outer edge 40 is non-perpendicular to the length of the inner surface 38. The outer surface 42 of the inner tube 28 is plastically deformed into engagement with the inner surface 38 of the outer tube 30. The inner tube 28 is deformed into engagement with the edge 40 of the outer tube thereby laterally and rotationally interlocking the tubes 28 and 30 to one another.

The outer tubes 14 and 30 may be used to locally stiffen the inner tubes 12 and 28 to provide mass damping, or provide an attachment location. For example, the outer tube 30 shown in FIGS. 2A and 2B, may include a flange 44 providing mounting features 46 such as holes. The flange 44 may be secured to the outer tube 30 by weld beads 48. To provide efficient manufacturing of the tubular structure 26 a plurality of outer tubes 30 may be cut from an outer tube assembly 50. The outer tubes 30 may be cut along lines C to provide the outer edge 40. It is to be understood that the outer edge may not be a surface defined by a single plane as shown, but rather the outer edge 40 merely needs to include an irregular shape sufficiently sized to receive a deformed portion of the inner tube 28 to lock the tubes to one another.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

What is claimed is:

1. A hydroformed tubular structure comprising:
an outer tube having a non-circular inner surface; and
an inner tube having an outer surface engaging said inner surface with a portion of said inner tubes spaced from outer tube having a cross-sectional shape different than a shape of said inner surface.

2. The structure according to claim 1, wherein a cross-section of said outer tube is quadrilateral and said cross-section of said portion of said inner tube is circular.

3. The structure according to claim 1, wherein said inner and outer tubes respectively have first and second Young's modulus of elasticity with said first modulus higher than said second modulus.

4. The structure according to claim 3, wherein said outer tube is titanium and said inner tube is steel.

5. A hydroformed tubular structure comprising:
an outer tube having an inner surface and an axis, said outer tube including an edge with a portion defined by a plane non-normal to said axis; and
an inner tube having an outer surface engaging said inner surface and said portion of said edge.

6. The structure according to claim 5, wherein said edge is non-normal to a longitudinal axis of a segment of said tubular structure.

7. The structure according to claim 6, wherein said edge is non-normal to a length of said inner surface.

8. A method of hydroforming a tubular structure comprising the steps of;
a) placing an outer tube over an inner tube;
b) hydroforming the inner tube plastically deforming the inner tube into engagement with the outer tube; and
c) rotationally locking into the inner and outer tubes together with an interlocking feature.

9. The method according to claim 8, wherein the interlocking feature is an irregular edge of the outer tube.

10. The method according to claim 9, wherein the interlocking feature is a non-circular inner surface of the outer tube.
